(19) United States
(12) Patent Application Publication
(10) Pub. No.: US 2026/0039052 A1
(43) Pub. Date: Feb. 5, 2026

(54) CONDUCTIVE MEMBER

(71) Applicant: YAZAKI CORPORATION, Tokyo (JP)

(72) Inventor: Ryota KATAOKA, Shizuoka (JP)

(73) Assignee: YAZAKI CORPORATION, Tokyo (JP)

(21) Appl. No.: 19/284,943

(22) Filed: Jul. 30, 2025

(30) Foreign Application Priority Data
Aug. 5, 2024 (JP) 2024-128886

(51) Int. Cl. H01R 13/506; H01R 13/424; H01R 25/16

(52) U.S. Cl. CPC H01R 13/506; H01R 13/424; H01R 25/161

(57) ABSTRACT

A conductive member includes a strip-shaped flat conductor, a pair of cover members made of an insulation resin, the cover members sandwiching and covering an intermediate portion of the flat conductor in a plate thickness direction, an opening prevention unit including a pair of engagement pieces protruding outward of two side edge portions of one of the cover members in a width direction and a pair of holding grooves provided on two side edge portions of the other one of the cover member and holding, in the plate thickness direction, the engagement pieces inserted along a longitudinal direction of the flat conductor, and a locking mechanism provided between the two side edge portions of the one of the cover members and the two side edge portions of the other one of the cover members and coupling the pair of cover members.

### CROSS-REFERENCE TO RELATED APPLICATIONS

This application is based on and claims priority under 35 USC 119 from Japanese Patent Application No. 2024-128886 filed on Aug. 5, 2024, the entire content of which is incorporated herein by reference.

### TECHNICAL FIELD

The present disclosure relates to a conductive member.

### BACKGROUND ART

In the related art, a conductive member that is connected to a power supply such as a battery and supplies electricity to an electrical component or the like has been used in a power supply circuit or the like. Such a type of conductive member may include a strip-shaped flat conductor (busbar) having a prescribed width.

The conductive member needs to ensure electrical insulation of the flat conductor. For example, there is known a technique of covering a flat conductor with an insulation material and a technique of insulating a flat conductor with a protector made of an insulation resin as disclosed in JP2014-107201A, JP2012-109152A, and JP2019-057459A.

For example, an electrical connection member (conductive member) disclosed in JP2019-057459A includes a busbar (flat conductor), a protector portion (case), and a cover.

The protector portion has a busbar placement surface on which a live electrical portion of the busbar is placed, and insulates and protects the live electrical portion. The protector portion has, in each of two positions in a width direction at each of two end portions thereof, a lock receiving portion that receives a lock portion of the cover.

The cover is coupled to the protector portion and covers a surface of the live electrical portion. The cover has, in each of two positions in the width direction at each of two end portions thereof, a lock portion for coupling the cover to the protector portion.

Therefore, the protector portion and the cover, which are a pair of cover members that face corresponding front and back surfaces of the busbar, constitute a busbar protector (protector) made of an insulation resin that remains a state of sandwiching the live electrical portion of the busbar in between from a plate thickness direction by coupling a locking mechanism including the lock receiving portion and the lock portion.

However, depending on a place where the above-described electrical connection member is routed, there may be no space for providing the locking mechanism in a desired position of the busbar protector due to an influence of peripheral components, and providing the locking mechanism may not be possible.

Therefore, since the locking mechanism cannot be provided, for example, in a vicinity of an opening at one of two end portions of the busbar protector in a longitudinal direction, the cover may be lifted and opened relative to the protector portion.

The present provides a conductive member that can prevent a pair of cover members covering a flat conductor from opening.

The object of the present disclosure described above is implemented by following configurations.

### SUMMARY OF INVENTION

A conductive member includes a strip-shaped flat conductor, a pair of cover members made of an insulation resin, the cover members respectively facing front and back surfaces of the flat conductor and sandwiching and covering an intermediate portion of the flat conductor in a plate thickness direction, an opening prevention unit including a pair of engagement pieces protruding outward of two side edge portions of one of the cover members in a width direction and a pair of holding grooves provided on two side edge portions of the other one of the cover member and holding, in the plate thickness direction, the engagement pieces inserted along a longitudinal direction of the flat conductor, and a locking mechanism provided between the two side edge portions of the one of the cover members and the two side edge portions of the other one of the cover members and coupling the pair of cover members.

According to the conductive member of the present disclosure, a pair of cover members covering a flat conductor can be prevented from opening.

The present disclosure has been briefly described above. Details of the present disclosure will be clarified by reading a mode (hereinafter, referred to as “embodiment”) for carrying out the disclosure to be described below with reference to the attached drawings.

### BRIEF DESCRIPTION OF DRAWINGS

FIG. 1 is a perspective view of a conductive member according to an embodiment of the present disclosure;

FIG. 2 is an exploded perspective view of the conductive member illustrated in FIG. 1;

FIGS. 3A and 3B are side views illustrating an assembling procedure of the conductive member according to the present embodiment;

FIG. 4 is a front view of the conductive member according to the present embodiment;

FIG. 5 is a perspective view of a conductive member according to a reference example; and

FIG. 6 is a side view illustrating a problem of the conductive member illustrated in FIG. 5.

### DESCRIPTION OF EMBODIMENTS

Hereinafter, an embodiment of the present disclosure will be described with reference to the drawings. Embodiment

A conductive member 1 according to the present embodiment is, for example, an inter-stack routing module used for electrical connection between a plurality of battery stacks. It is needless to say that the conductive member 1 of the present disclosure can be applied not only to the inter-stack routing module according to the present embodiment but also to various power supply circuits such as a high-voltage cable that electrically connects a battery assembly and a control device such as an inverter.

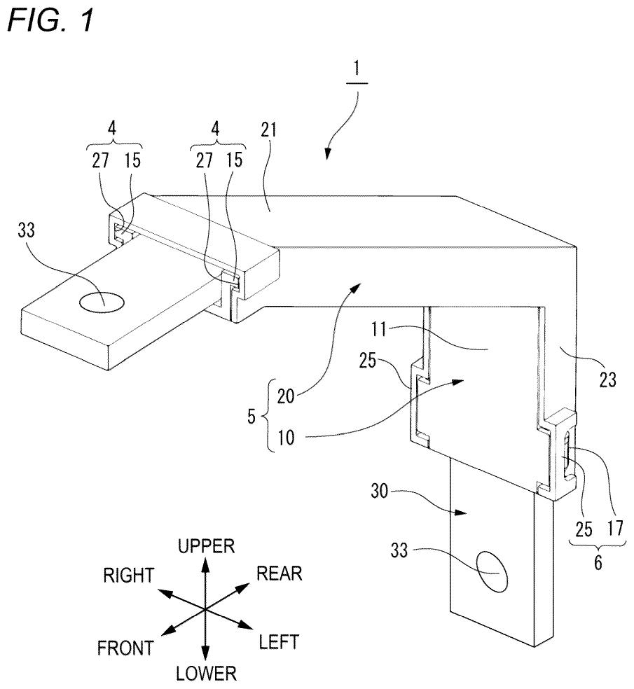

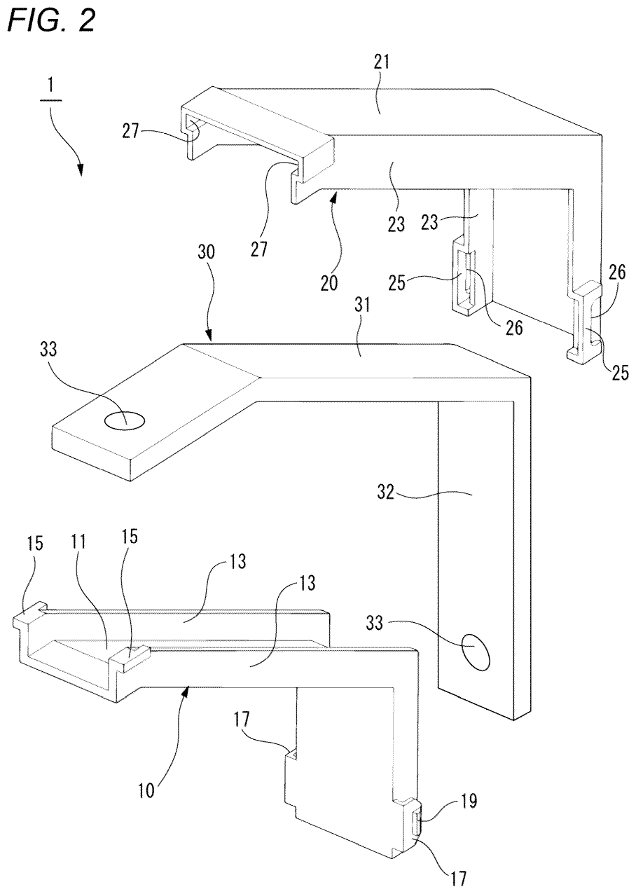

FIG. 1 is a perspective view of the conductive member 1 according to the embodiment of the present disclosure. FIG. 2 is an exploded perspective view of the conductive member 1 illustrated in FIG. 1. In the present embodiment, upper-lower, front-rear, and left-right directions of the conductive member 1 follow upper-lower, front-rear, and left-right directions indicated by arrows in FIG. 1.

As illustrated in FIGS. 1 and 2, the conductive member 1 according to the present embodiment mainly includes a strip-shaped flat conductor (busbar) 30, and a case 10 and a cover 20 that are a pair of cover members made of an insulation resin and accommodate an intermediate portion of the flat conductor 30. The case 10 and the cover 20 integrally molded by injection molding or the like constitute a protector 5 made of an insulation resin.

As illustrated in FIG. 2, the flat conductor 30 according to the present embodiment is formed of an elongated flat plate-shaped conductive metal plate bent into a substantially L shape in a side view such that two end portions thereof extend in directions perpendicular to each other. The protector 5 (case 10, cover 20) is formed with a bolt through hole 33 in each of the two end portions of the flat conductor 30 that are exposed from the protector 5.

Various conductive metal materials such as copper, a copper alloy, aluminum, and an aluminum alloy can be used for the conductive metal plate.

As illustrated in FIG. 2, the case 10 (one of the cover members) according to the present embodiment includes a bottom wall portion 11 along a lower face (back surface) 32 of the flat conductor 30 and two side wall portions 13 vertically provided on two side edge portions of the bottom wall portion 11 in a left-right width direction, and has a substantially L-shaped outer shape in a side view. In the case 10, the bottom wall portion 11 and the two side wall portions 13 define an accommodation groove that accommodates an intermediate portion (live electrical portion) of the flat conductor 30, so that the intermediate portion of the flat conductor 30 is accommodated therein.

The case 10 is further provided with, at one end portions of the two side wall portions 13 in the longitudinal direction on a front side of the case 10, a pair of engagement pieces 15 protruding outward in a width direction from the two side edge portions of the case 10. The engagement pieces 15 are rib-shaped protrusions extending parallel to an extending direction of a front end portion of the flat conductor 30.

The case 10 is further provided with, at the other end portions of the two side wall portions 13 in the longitudinal direction on a rear side of the case 10, case-side lock portions 17 rising vertically outward of the two side wall portions 13 that are two side edge portions of the bottom wall portion 11 in the left-right width direction. Each of the case-side lock portions 17 is provided with, on an outer surface side thereof, an engagement claw 19 that is fitted and locked into a locking hole 26 of a cover-side lock portion 25 described later. As illustrated in FIG. 2, the cover (the other one of the cover members) 20

according to the present embodiment includes an upper wall portion 21 along an upper face (front surface) 31 of the flat conductor 30, and two side wall portions 23 hanging from two side edge portions of the upper wall portion 21 in the left-right width direction, and has a substantially L-shaped outer shape in a side view. The cover 20 covers an upper opening of the case 10, which accommodates the intermediate portion of the flat conductor 30, with the upper wall portion 21 and the two side wall portions 23.

The cover 20 is further provided with, at one end portions of the two side wall portions 23 in the longitudinal direction on a front side of the cover 20, a pair of holding grooves 27 recessed inward in a width direction from the two side edge portions of the cover 20. The holding grooves 27 are grooves each having a rectangular cross section and extending parallel to an extending direction of a front end portion of the flat conductor 30, so as to hold the engagement pieces 15 of the case 10 inserted along the longitudinal direction of the flat conductor 30 in a plate thickness direction.

The cover 20 is further provided with the cover-side lock portions 25 respectively at the other end portions of the two side wall portions 23 in the longitudinal direction on a rear side of the cover 20. Each of the cover-side lock portions 25 is provided with the vertically running locking hole 26 having a rectangular cross section.

When the cover 20 is installed to the case 10, the engagement claws 19 of the case-side lock portions 17 enter the locking holes 26 of the cover-side lock portions 25. Accordingly, the engagement claws 19 of the case-side lock portions 17 are fitted into and locked to the locking holes 26 of the cover-side lock portions 25, and the case-side lock portions 17 and the cover-side lock portions 25 are engaged and locked with each other.

That is, an opening prevention unit 4, which is implemented by the pair of engagement pieces 15 and the pair of holding grooves 27 that respectively hold the pair of engagement pieces 15 in the plate thickness direction, is provided at one end portion (desired position) of the protector 5 constituted by the case 10 and the cover 20 in the longitudinal direction.

Further, at the other end portion (desired position) of the protector 5 in the longitudinal direction, a locking mechanism 6, which couples the case 10 and the cover 20 along a direction of sandwiching the flat conductor 30 from the plate thickness direction by the case-side lock portions 17 and the cover-side lock portions 25, is provided between the two side edge portions of the case 10 and the two side edge portions of the cover 20.

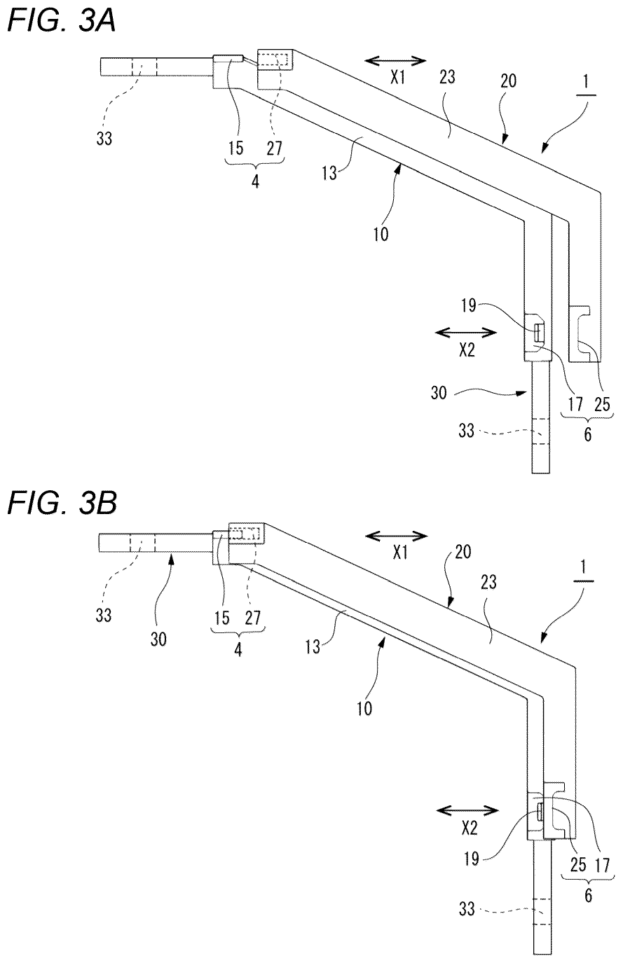

A coupling and decoupling direction X2 of the case-side lock portions 17 and the cover-side lock portions 25 of the locking mechanism 6 is parallel to an insertion and removal direction X1 of the engagement pieces 15 relative to the holding grooves 27 of the opening prevention unit 4 (see FIGS. 3A and 3B).

Further, the engagement pieces 15 of the opening prevention unit 4 are fitted into the holding grooves 27 before the cover-side lock portions 25 are coupled to the case-side lock portions 17 of the locking mechanism 6 (see FIGS. 3A and 3B).

Next, an assembly procedure of the conductive member 1 will be described.

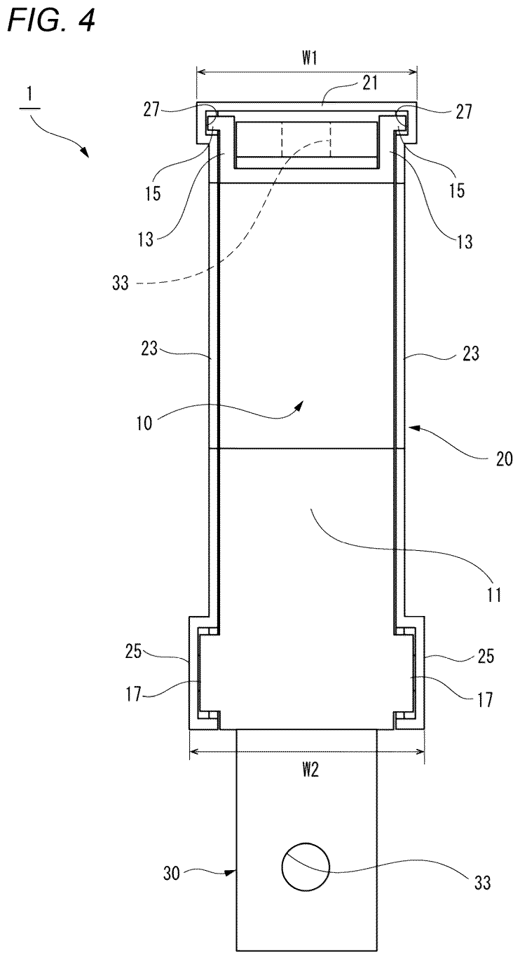

FIGS. 3A and 3B are side views illustrating an assembling procedure of the conductive member 1 according to the present embodiment. FIG. 4 is a front view of the conductive member 1 according to the present embodiment.

First, the intermediate portion of the flat conductor 30 is placed along the bottom surface of the bottom wall portion 11 of the case 10. Two side edge portions of the flat conductor 30 placed along the bottom surface of the bottom wall portion 11 are covered with the two side wall portions 13.

Next, as illustrated in FIG. 3A, the cover 20 is brought close to the case 10 from behind to cover the upper opening of the case 10 accommodating the intermediate portion of the flat conductor 30. At this time, the cover 20 is brought close from rear of the case 10 such that the holding grooves 27 are along the insertion and removal direction X1 of the opening prevention unit 4 and the cover-side lock portions 25 are along the coupling and decoupling direction X2 of the locking mechanism 6.

Then, as illustrated in FIG. 3B, when the cover 20 is brought further closer to the case 10 from behind, the engagement pieces 15 are inserted into the holding grooves 27 in the opening prevention unit 4 along the longitudinal direction of the flat conductor 30 to start fitting, before the cover-side lock portions 25 are coupled to the case-side lock portions 17 in the locking mechanism 6.

Therefore, before the locking mechanism 6 is coupled, the pair of holding grooves 27 of the cover 20 are fitted to the pair of engagement pieces 15 of the case 10, and thereby the cover 20 can be positioned relative to the case 10 and the cover 20 can be fitted and guided along the insertion and removal direction X1. The holding grooves 27 of the cover 20 hold the engagement pieces 15 of the case 10 in the plate thickness direction of the flat conductor 30.

Thereafter, the pair of case-side lock portions 17 pass through the locking holes 26 of the pair of cover-side lock portions 25, respectively, and the engagement claws 19 of the case-side lock portions 17 engage with opening edges of the locking holes 26. That is, the engagement claws 19 formed on the outer surface sides of the pair of case-side lock portions 17 of the case 10 are locked to the opening edges of the locking holes 26, respectively, and are restricted from being detached from the locking holes 26.

At this time, the cover-side lock portions 25 can be smoothly coupled to the case-side lock portions 17 along the coupling and decoupling direction X2 parallel to the insertion and removal direction X1, and thus ease of assembly of the cover 20 is improved.

In the protector 5 including the case 10 and the cover 20 that face front and back surfaces of the flat conductor 30 and cover the flat conductor 30 from the plate thickness direction, the cover 20 is prevented from being lifted and opened relative to the case 10 by the opening prevention unit 4 provided at one end portion in the longitudinal direction. In the protector 5, the case 10 and the cover 20 are integrally held by the locking mechanism 6 provided at the other end portion in the longitudinal direction.

Next, effects of the above-described configurations will be described.

FIG. 4 is a front view of the conductive member 1 according to the present embodiment.

According to the conductive member 1 in the present embodiment, the front and back surfaces of the flat conductor 30 excluding the two end portions where the bolt through holes 33 are formed are covered with the protector 5. Accordingly, the conductive member 1 can have good electrical insulation as a routing member.

In the conductive member 1 according to the present embodiment, the cover 20 is prevented from being lifted and opened relative to the case 10 by the opening prevention unit 4 provided at one end portion (desired position) of the protector 5 in the longitudinal direction, and the case 10 and the cover 20 are integrally held by the locking mechanism 6 provided at the other end portion (desired position) of the protector 5 in the longitudinal direction.

As illustrated in FIG. 4, the opening prevention unit 4 implemented by the pair of engagement pieces 15 and the pair of holding grooves 27 has a width W1 smaller than a width W2 of the locking mechanism 6 implemented by the case-side lock portions 17 and the cover-side lock portions 25, and is more compact than the locking mechanism 6.

Therefore, the opening prevention unit 4 can be provided even when there is no space for providing the locking mechanism 6 at one end portion (desired position) of the protector 5 in the longitudinal direction due to an influence of peripheral components.

Therefore, according to the conductive member 1 in the present embodiment, by providing the opening prevention unit 4 at one end portion (desired position) of the protector in the longitudinal direction where the locking mechanism 6 cannot be provided, it is possible to prevent the cover 20 from being lifted relative to the case 10 and prevent the opening from being opened.

### Reference Example

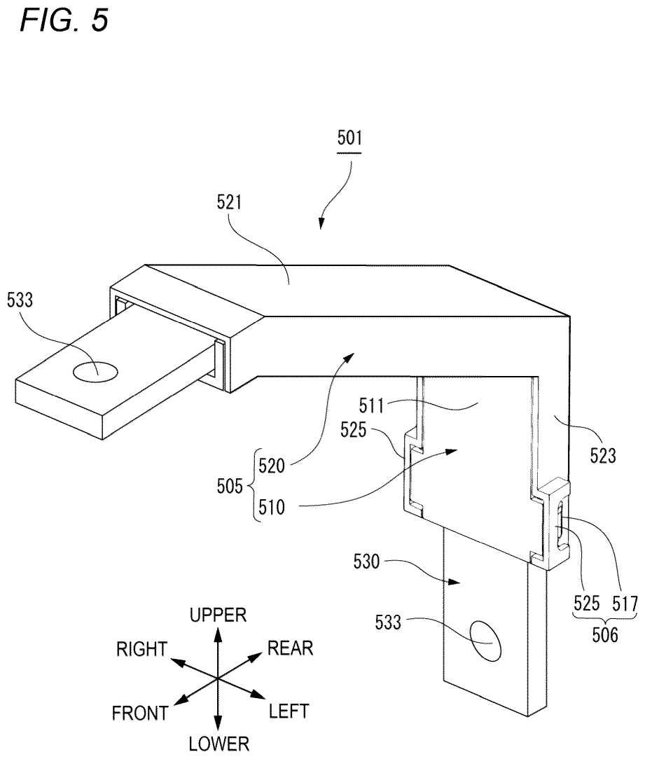

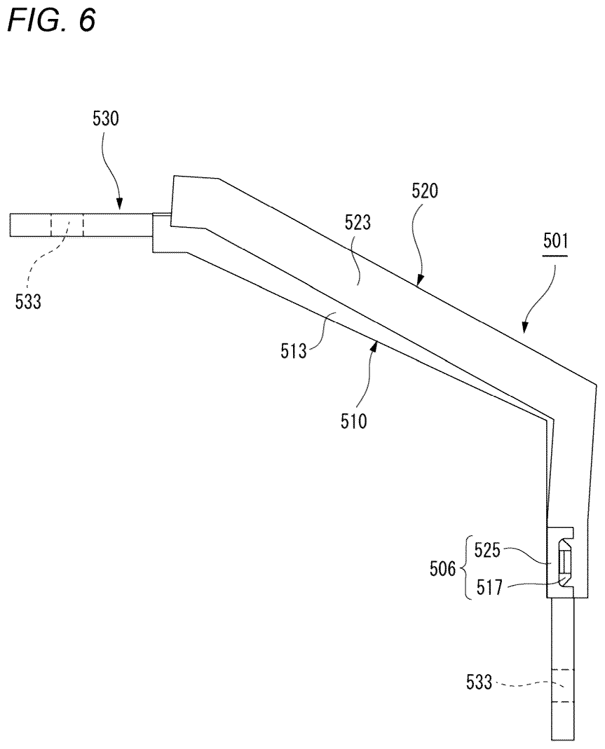

FIG. 5 is a perspective view of a conductive member 501 according to a reference example. FIG. 6 is a side view illustrating a problem of the conductive member 501 illustrated in FIG. 5.

As illustrated in FIG. 5, the conductive member 501 according to the reference example mainly includes a strip-shaped flat conductor 530, and a case 510 and a cover 520 that accommodate an intermediate portion of the flat conductor 530. The case 510 and the cover 520 integrally molded by injection molding or the like constitute a protector 505 made of an insulation resin.

The flat conductor 530 is formed of an elongated flat plate-shaped conductive metal plate bent into a substantially L shape in a side view such that two end portions thereof extend in a direction perpendicular to each other. The protector 505 (case 510, cover 520) is formed with a bolt through hole 533 in each of the two end portions of the flat conductor 530 that are exposed from the protector 505.

The case 510 includes a bottom wall portion 511 along a lower face of the flat conductor 530, and two side wall portions 13 vertically provided on two side edge portions of the bottom wall portion 511 in the left-right width direction, and has a substantially L-shaped outer shape in a side view. In the case 510, the bottom wall portion 511 and the two side wall portions 13 define an accommodation groove that accommodates the intermediate portion of the flat conductor 530, so that the intermediate portion of the flat conductor 530 is accommodated therein.

The case 510 is further provided with, at one end portions of the two side wall portions 513 in the longitudinal direction on a rear side of the case 510, case-side lock portions 517 rising vertically outward of the two side wall portions 513 that are two side edge portions of the bottom wall portion 511 in the left-right width direction.

The cover 520 includes an upper wall portion 521 along an upper face of the flat conductor 530, and two side wall portions 523 hanging from two side edge portions of the upper wall portion 521 in the left-right width direction, and has a substantially L-shaped outer shape in a side view. The cover 520 covers an upper opening of the case 510, which accommodates the intermediate portion of the flat conductor 530, with the upper wall portion 521 and the two side wall portions 523.

The cover 520 is further provided with cover-side lock portions 525 respectively at one end portions of the two side wall portions 523 in the longitudinal direction on a rear side of the cover 520.

When the cover 520 is installed to the case 510, the cover-side lock portions 525 are locked to the case-side lock portions 517, and the case-side lock portions 517 and the cover-side lock portions 525 are engaged and locked with each other.

That is, a locking mechanism 506, which couples the case 510 and the cover 520 along a direction of sandwiching the flat conductor 530 from the plate thickness direction by the case-side lock portions 517 and the cover-side lock portions 525, is provided at one end portion of the protector 505 in the longitudinal direction on a rear side.

The locking mechanism 506 is not provided at an end portion of the protector 505 in the longitudinal direction on a front side in order to avoid an influence of peripheral components.

Therefore, in the conductive member 501, the case 10 and the cover 20 that sandwich and cover the flat conductor 30 are integrally held only by the locking mechanism 6 provided at the end portion of the protector 505 in the longitudinal direction on the rear side.

Therefore, when the flat conductor 530 is sandwiched and covered by the protector 505, as illustrated in FIG. 6, there is a problem that the cover 520 on the front side of the protector 505 is lifted relative to the case 510 and a front opening is opened.

On the other hand, in the conductive member 1 according to the present embodiment, the opening prevention unit 4 is provided at one end portion of the protector 5 in the longitudinal direction where there is no space for providing the locking mechanism 6 due to an influence of peripheral components.

Therefore, according to the conductive member 1 in the present embodiment, by providing the opening prevention unit 4 in a vicinity of the opening at one end portion of the protector 5 in the longitudinal direction where the locking mechanism 6 cannot be provided, it is possible to prevent the cover 20 from being lifted relative to the case 10 and prevent the opening from being opened.

In the conductive member 1 according to the present embodiment, the coupling and decoupling direction X2 of the locking mechanism 6 is parallel to the insertion and removal direction X1 of the engagement pieces 15 relative to the holding grooves 27.

Therefore, insertion and removal of the engagement pieces 15 into and from the holding grooves 27 and coupling and decoupling of the locking mechanism 6 can be smoothly performed at the same time.

Further, the engagement pieces 15 in the opening prevention unit 4 are fitted into the holding grooves 27 before the cover-side lock portions 25 are coupled to the case-side lock portions 17 in the locking mechanism 6.

Therefore, before the locking mechanism 6 is coupled, the pair of holding grooves 27 of the cover 20 are fitted to the pair of engagement pieces 15 of the case 10, and thereby the cover 20 can be positioned relative to the case 10 and the cover 20 can be fitted and guided along the insertion and removal direction X1. Therefore, the cover-side lock portions can be smoothly coupled to the case-side lock portions 17 along the coupling and decoupling direction X2 parallel to the insertion and removal direction X1, and ease of assembly of the cover 20 relative to the case 10 is improved.

In the conductive member 1 according to the present embodiment, the opening prevention unit 4 is provided at one end portion of the case 10 and the cover 20 in the longitudinal direction, and the locking mechanism 6 is provided at the other end portion of the case 10 and the cover 20 in the longitudinal direction.

Therefore, it is possible to reliably prevent openings at two ends of the protector 5 constituted by the case 10 and the cover 20 from being opened.

In the conductive member 1 according to the present embodiment, the flat conductor 30 is bent such that two end portions thereof extend in directions perpendicular to each other.

Therefore, it is possible to reliably prevent an opening between the cover 20 and the case 10, which sandwich and cover the bent flat conductor 30, from being opened.

Therefore, according to the conductive member 1 in the present embodiment, the opening between the cover 20 and the case 10, which cover the flat conductor 30, can be prevented.

The present disclosure is not limited to the embodiment described above, and can be appropriately modified, improved, or the like. Materials, shapes, sizes, numbers, arrangement positions, and the like of components in the embodiment described above are freely selected and are not limited as long as the present disclosure can be implemented.

For example, in the conductive member 1 according to the above embodiment, the locking mechanism 6, which couples the case 10 and the cover 20 along the direction of sandwiching the flat conductor 30 from the plate thickness direction, is provided. The locking mechanism of the present disclosure is not limited thereto, and may be a locking mechanism that couples a case and a cover by sliding the case and the cover along a longitudinal direction of a linear flat conductor.

Here, features of the conductive member of the present disclosure described above will be briefly summarized and listed in [1] to [5] below.
[1] A conductive member (1) includes:
a strip-shaped flat conductor (30);
a pair of cover members (case 10, cover 20) made of an insulation resin, the cover members (case 10, cover 20) respectively facing front and back surfaces (31, 32) of the flat conductor (30) and sandwiching and covering an intermediate portion of the flat conductor (30) in a plate thickness direction;
an opening prevention unit (4) including a pair of engagement pieces (15) protruding outward of two side edge portions of one of the cover members (case 10) in a width direction and a pair of holding grooves (27) provided on two side edge portions of the other one of the cover member (cover 20) and holding, in the plate thickness direction, the engagement pieces (15) inserted along a longitudinal direction of the flat conductor (30); and
a locking mechanism (6) provided between the two side edge portions of the one of the cover members (case 10) and the two side edge portions of the other one of the cover members (cover 20) and coupling the pair of cover members (case 10, cover 20).

According to the conductive member (1) in [1], by providing the opening prevention unit (4) in a desired position of the pair of cover members (case 10, cover 20) where there is no space for providing the locking mechanism 6 due to an influence of peripheral components, it is possible to prevent the cover 20 from being lifted relative to the case 10 and prevent an opening from being opened.
[2] In the conductive member (1) according to [1], a coupling and decoupling direction (X2) of the locking mechanism (6) is parallel to an insertion and removal direction (X1) of the engagement pieces (15) relative to the holding grooves (27).

According to the conductive member (1) in [2], insertion and removal of the engagement pieces (15) into and from the holding grooves (27) and coupling and decoupling of the locking mechanism (6) can be smoothly performed at the same time.
[3] In the conductive member (1) according to [2], the engagement pieces (15) and the holding grooves (27) start to be fitted to each other before the locking mechanism (6) couples the pair of cover members (case 10, cover 20).

According to the conductive member (1) described in [3], the pair of holding grooves (27) of the other one of the cover members (cover 20) are fitted to the pair of engagement pieces (15) of the one of the cover members (case 10) before the locking mechanism (6) is coupled, so that the other one of the cover members (cover 20) can be positioned relative to the one of the cover members (case 10), and the other one of the cover members (cover 20) can be fitted and guided along the insertion and removal direction (X1). Therefore, the locking mechanism (6) can be smoothly coupled along the coupling and decoupling direction (X2) parallel to the insertion and removal direction (X1), and ease of assembly of the pair of cover members (case 10, cover 20) is improved.
[4] In the conductive member (1) according to [3], the opening prevention unit (4) is provided at one end portion of the pair of cover members (case 10, cover 20) in the longitudinal direction, and the locking mechanism (6) is provided at the other end portion of the pair of cover members (case 10, cover 20) in the longitudinal direction.

According to the conductive member (1) in [4], it is possible to reliably prevent openings at two ends of the pair of cover members (case 10, cover 20) from being opened.
[5] In the conductive member according to any one of [1] to [4], the flat conductor (30) is bent such that two end portions thereof extend in directions perpendicular to each other.

According to the conductive member (1) in [5], the pair of cover members (case 10, cover 20) that sandwich and cover the bent flat conductor (30) can be reliably prevented from being opened.

What is claimed is:

1. A conductive member comprising:
a strip-shaped flat conductor;
a pair of cover members made of an insulation resin, the cover members respectively facing front and back surfaces of the flat conductor and sandwiching and covering an intermediate portion of the flat conductor in a plate thickness direction;
an opening prevention unit including a pair of engagement pieces protruding outward of two side edge portions of one of the cover members in a width direction and a pair of holding grooves provided on two side edge portions of the other one of the cover member and holding, in the plate thickness direction, the engagement pieces inserted along a longitudinal direction of the flat conductor; and
a locking mechanism provided between the two side edge portions of the one of the cover members and the two side edge portions of the other one of the cover members and coupling the pair of cover members.

2. The conductive member according to claim 1,
wherein a coupling and decoupling direction of the locking mechanism is parallel to an insertion and removal direction of the engagement pieces relative to the holding grooves.

3. The conductive member according to claim 2,
wherein the engagement pieces and the holding grooves start to be fitted to each other before the locking mechanism couples the pair of cover members.

4. The conductive member according to claim 3,
wherein the opening prevention unit is provided at one end portion of the pair of cover members in the longitudinal direction, and the locking mechanism is provided at the other end portion of the pair of cover members in the longitudinal direction.

5. The conductive member according to claim 1,
wherein the flat conductor is bent such that two end portions thereof extend in directions perpendicular to each other.
